(19) United States
(12) Patent Application Publication
(10) Pub. No.: US 2014/0349766 A1
(43) Pub. Date: Nov. 27, 2014

(54) METHOD AND SERVER FOR PROVIDING SIMULATION GAME

(71) Applicant: Intellectual Discovery Co., Ltd., Seoul (KR)

(72) Inventors: Jeong Hun Kim, Seoul (KR); Min Seong Kim, Yongin-si (KR)

(73) Assignee: Intellectual Discovery Co., Ltd., Seoul (KR)

(21) Appl. No.: 14/369,858

(22) PCT Filed: Nov. 21, 2012
(86) PCT No.: PCT/KR2012/009858

§ 371 Date: Jun. 30, 2014

(30) Foreign Application Priority Data
Dec. 28, 2011 (KR) 10-2011-0145234

(51) Int. Cl. A63F 13/30

(52) U.S. Cl. CPC A63F 13/12
USPC 463/42

(57) ABSTRACT

Disclosed is a technique for providing a mini-game and correcting a capability point of a simulation game character before a simulation game, and a game for artificial intelligence of a computer to display a playing result in place of a user. The technique includes: receiving an input for beginning a simulation game that is a game for artificial intelligence of a computer to display a playing result in place of a user from among game types existing in a multi-play mode that is a game mode in which users play a game by themselves from a simulation game providing user terminal; providing a mini-game that is a predetermined game for correcting a capability point of a character in the game when receiving the input of the simulation game; correcting the capability point of the character according to a result of the mini-game; and playing the simulation game based on the corrected capability point of the character.

### TECHNICAL FIELD

The present invention relates to a technique for providing a mini-game and correcting a capability point of a simulation game character before a simulation game that is a game for displaying a playing result by artificial intelligence of a computer in place of a user.

### BACKGROUND ART

Together with recent development of graphics skills, as online network services have been developed, a number of users using game contents has been steeply increased. Various types of game contents are provided so that users may feel vicarious satisfaction by manipulating characters acting as their proxies in the virtual world or manipulating various objects existing in the real world.

For example, the users can relieve stress of the real world in the virtual world and have fun by generating characters in place of themselves in a fantasy world, increasing a level of the character, and allowing them to perform various acts.

In another way, in the sports game, they can feel vicarious pleasure and feel interested by manipulating characters having implemented soccer players who exist in the actual world and allowing them to have a chance to becoming a director, a player, or an owner of a team in the soccer game.

Among the above-noted games, there is a simulation game that is a game for, when the user sets a game environmental factor, allowing artificial intelligence of a computer to use the game environmental factor set by the user and display a playing result in place of the user.

### DISCLOSURE

### Technical Problem

The present invention has been made in an effort to provide a method and server for providing a simulation game for providing a mini-game to correct a capability point of a game character, and acquiring information on the user's team formation and a game character's growth direction through a game result of simulation before a simulation game that is a game for artificial intelligence of a computer to display a playing result in place of a user start.

### Technical Solution

An exemplary embodiment of the present invention provides a method for providing a simulation game, including: by an online game executing server, receiving an input for beginning a simulation game that is a game for artificial intelligence of a computer to display a playing result in place of a user from among game types existing in a multi-play mode that is a game mode in which users play a game by themselves from a user terminal; providing a mini-game that is a predetermined game for correcting a capability point of a character in the game when receiving the input of the simulation game; correcting the capability point of the character according to a result of the mini-game; and playing the simulation game based on the corrected capability point of the character. The receiving of an input for beginning a simulation game includes: receiving a game generating input from the user terminal; transmitting a game type selecting menu as a menu for selecting one of game types existing in the multi-play mode to the user terminal when receiving the game generating input; generating the simulation game when selecting the simulation game from the game type selecting menu; and receiving an input for beginning the simulation game from the user terminal when an opponent participates in the simulation game.

The mini-game includes: moving at least one block-shaped puzzle having a random image corresponding to a type of the game character in a specific direction; allowing the moved puzzle to form a specific pattern with same puzzles that were moved; and correcting a capability point of a character corresponding to a removed puzzle simultaneously when the puzzle having formed a specific pattern is removed.

The method further includes finishing the mini-game when a predetermined time is passed.

The method further includes transmitting a capability point correction result of the character to the user terminal stage.

The method further includes, when receiving an input for beginning the simulation game, performing at least one predetermined stage that must be preceded before the simulation game playing starts.

The at least one predetermined stage that must be preceded includes exchanging at least one character played in the game or changing a state of the at least one character, as setting of the at least one game factor.

Another embodiment of the present invention provides a server for providing a simulation game, including: an input receiver for receiving an input for beginning a simulation game that is a game for artificial intelligence of a computer to display a playing result in place of a user from among game types existing in a multi-play mode that is a game mode in which users can play a game by themselves from a user terminal; a provider for providing a mini-game that is a predetermined game performed to correct a capability point of a character in the game when receiving the input of the simulation game; and a controller for correcting the capability point of the character according to a result of the mini-game, and controlling to play the simulation game based on the capability point of the corrected character.

The input receiver transmits a game type selecting menu as a menu for selecting one of game types existing in the multi-play mode to the user terminal when receiving a game generating input from the user terminal, generates the simulation game when selecting the simulation game from the game type selecting menu, and receives an input for beginning the simulation game from the user terminal when an opponent participates in the simulation game.

The provider provides a mini-game for moving at least one block-shaped puzzle having a random image corresponding to a type of the game character in a specific direction, allowing the moved puzzle to form a specific pattern with same puzzles that were moved, and correcting a capability point of a character corresponding to a removed puzzle simultaneously when the puzzle having formed a specific pattern is removed.

The controller finishes the mini-game when a predetermined time is passed.

The controller transmits a capability point correction result of the character to the user terminal.

The controller controls to perform at least one predetermined stage that must be preceded before the simulation game playing begins when receiving the input for beginning the simulation game.

The at least one predetermined stage that must be preceded includes, as a stage for setting the at least one game factor, exchanging at least one character playing in the game or changing a state of the at least one character.

Yet another embodiment of the present invention provides a computer readable medium for recording a program for realizing a method for providing a simulation game including: by an online game executing server, receiving an input for beginning a simulation game that is a game for artificial intelligence of a computer to display a playing result in place of a user from among game types existing in a multi-play mode that is a game mode in which users can play a game by themselves from a user terminal; providing a mini-game that is a predetermined game performed to correct a capability point of a character in the game when receiving the input of the simulation game; correcting the capability point of the character according to a result of the mini-game; and playing the simulation game based on the capability point of the corrected character.

### Advantageous Effects

According to the embodiments of the present invention, the capability point of the game character is corrected by providing a mini-game before a simulation game begins, and information on the user's team formation and the game character's growth direction is acquirable through the game result of simulation.

### DESCRIPTION OF THE DRAWINGS

FIG. 1 shows an operational flowchart of a method for providing a simulation game according to an exemplary embodiment of the present invention.

FIG. 2 shows an operational flowchart of a method for a mini-game according to an exemplary embodiment of the present invention.

FIG. 3 shows a block diagram of a configuration on a server for providing a simulation game according to an exemplary embodiment of the present invention.

FIG. 4 to FIG. 7 show exemplary game screens that are applicable according to respective exemplary embodiments of the present invention.

### MODE FOR INVENTION

Hereinafter, referring to accompanying drawings, a simulation game providing method and server according to respective exemplary embodiments of the present invention will be described.

In the following description, in order to clearly understand the present invention, description of a known technology regarding a characteristic of the present invention will be omitted. It is obvious that the following exemplary embodiment is a detailed description which is provided for better understanding of the present invention but does not limit the scope of the present invention. Therefore, an equivalent invention which performs the same function as the present invention may also be covered by the scope of the present invention.

In the following description, like reference numerals designate like elements having the same configuration, and redundant description and description of a known technology will be omitted.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer to which users access to use game contents. In the case of a game which has a small capacity or a small number of users, a plurality of game programs may be operated by one game server. Further, in the case of a game which has a large capacity or a large number of real time accessing members, one or more game servers which operate one game may be provided depending on a function of the game.

In addition, middleware for databases or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game in the game. The online game also indicates a game in which various kinds of items can be bought in the game to play the game more smoothly.

Also, in the online game according to the present invention, various community systems are usable. For example, a guild or a clan of the online game may be formed. The concept signifies that users using an online game gather together make a group and form an organization. The guild or the clan may be increased according to a number of users or levels of characters of the users, and accordingly each organization may use various benefits in the game. For example, when the fame of the guild or the clan is increased, displaying of the character on the game screen may be different (e.g., an effect of changing a color of a name of the displayed character), or the user may enjoy the benefits when using items and villages in the game.

Further, a community system that can be used in the online game is a party play. The party play is a group of the game play, which is formed through requests, invitations, and acceptance by the users, and formed party members can use their own chat system or use specific marks for identifying the party members on the game screen.

Also, the users doing party play can distribute items to each other or can share resultant contents acquired by the result of game play with each other. The sharing method can be set by sharing the resultant contents by themselves or distributing at least part of the resultant contents to other characters.

In the present invention, the resultant contents signify all contents acquirable by the characters of the users according to a play result while playing a game. For example, in the case of a shooting game, an experience point and cyber money that can be obtained when a game is over can belong to the resultant contents, and in the case of a sports game, an experience point and cyber money that can be obtained when a game is over can be resultant contents. In the case of a role playing game, an experience point and reward cyber money acquirable when a specific quest is completed or a monster is destroyed can become resultant contents.

When the user's character acquires specific resultant contents in the online game, the resultant contents are set to belong to the character of the user as a default. However, when he belongs to a party play, a guild, or a clan, at least part of the resultant contents acquired by him can be distributed to the characters of other users belonging to the party, guild, or clan.

Herein, an item indicates all data that can give assistance to playing the game and can be generally understood as an item on the game. For example, in a role playing game, an item for further increasing an experience level obtained when a character of a user subdues a monster, an item for changing the appearance of the character, and the like may correspond to the items in the present invention.

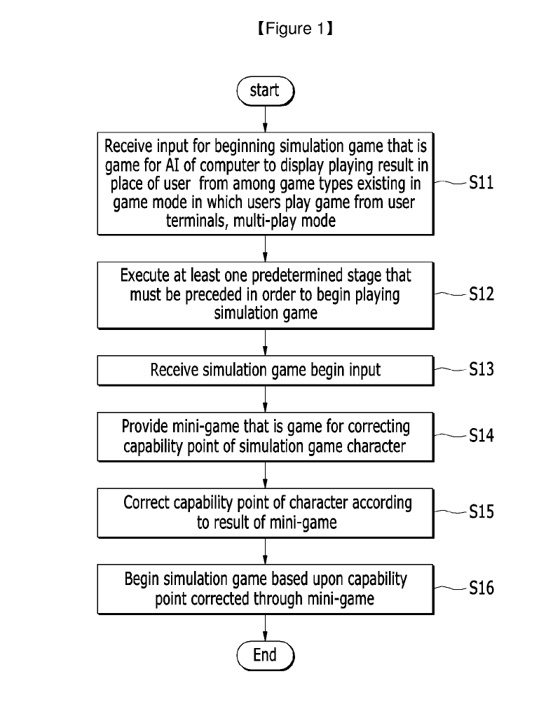

FIG. 1 shows an operational flowchart of a method for providing a simulation game according to an exemplary embodiment of the present invention.

Referring to FIG. 1, regarding the method for providing a simulation game according to an exemplary embodiment of the present invention, a server for performing a game performs a step S11 for receiving an input for beginning a simulation game that is a game for artificial intelligence of a computer to display a playing result in place of the user from among game types existing in a multi-play mode that is a game mode in which users play a game by themselves from a user terminal.

Here, the server for receiving an input for beginning a simulation game receives a game generating input from the user terminal, transmits a game type selecting menu as a menu for selecting one of game types existing in the multi-play mode to the user terminal when receiving the game generating input, generates a simulation game when selecting a simulation game from the game type selecting menu, and receives an input for beginning a simulation game from the user terminal when an opponent participates in the simulation game.

In the present invention, for example, the simulation game is displayed with a game room generating menu on a game screen. When the user selects a game room entering menu by using a pointing means such as a mouse, a simulation menu for executing a simulation game linked with the game room entering menu is displayed.

Upon receiving the simulation game input from the user terminal, the server performs a step S12 for performing at least one predetermined step that must be preceded before a simulation game play begins.

In the present invention, the at least one predetermined step that must be preceded is a stage for setting at least one game environmental factor relating to a simulation game play, and the game environmental factor signifies a factor for controlling a value of a capability point owned by a registered item or an additional effect in the simulation game play. For example, the capability point value of the user character to be improved by mounting an item is variable depending on the game environmental factor. The game environmental factor can be differently set for each item.

For an instance of the sports game, the registered item can be a player character. In this instance, the game environmental factor can include at least one of a condition factor and a physical strength factor of the player character.

The condition factor represents a factor for changing an applied capability point when the capability point owned by the player character is used in the game play. In this instance, the capability point that is applied by the condition is changeable with a predetermined ratio. The condition factor can be divided into a predetermined number such as “top, top middle, middle, middle bottom, and bottom”. When the condition factor is top, the applied capability point is increased more than the capability point owned by the player character by a predetermined ratio, and it is applicable when playing a game, and when the condition factor is bottom, the applied capability point is reduced more than the capability point owned by the player character by a predetermined ratio and it is applicable when playing a game.

The physical strength factor is a factor consumed according to game playing, and when the physical strength factor is consumed, the applied capability point is reduced. For example, the applied capability point is reduced by a predetermined ratio, and it is applicable to game playing when the physical strength is 70 compared to the case in which it is 100. The physical strength factor can be reduced in real-time while playing a game, and it is reduced when playing a game with respect to the physical strength factor just before playing a game.

Therefore, the condition factor and the physical strength factor are included in the game environmental factor for controlling the value to which the capability point owned by the item is applied when playing the game, and the user uses an item having another capability point according to the game environmental factor.

When the predetermined stage that must be preceded is performed, the server can generate a message for notifying inputting of a start button so as to start a mini-game since the predetermined stage that must be preceded before a simulation game playing begins is finished, and then can transmit it to the user terminal.

The server performs a step S13 for receiving a simulation game begin input from the user terminal.

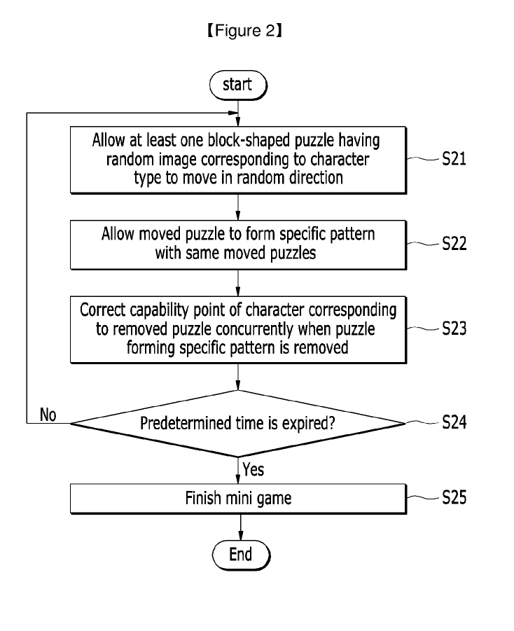

The server having received the simulation game begin input performs a step S14 for providing a mini-game that is a game for correcting the capability point of the simulation game character. The mini-game will be described with reference to FIG. 2.

The server performs a step S15 for correcting the capability point of the simulation game character according to a result of the mini-game. The capability point of the character can be improved or reduced according to the result of the mini-game.

When the capability point of the character is corrected through the mini-game, the server performs a step S16 for beginning a simulation game based on the corrected capability point.

The mini-game is provided before the simulation game starts to correct the capability point of the game character, and information on the user's team formation and game character's growth direction is acquirable through a game result of simulation.

FIG. 2 shows an operational flowchart of a method for a mini-game according to an exemplary embodiment of the present invention.

When the mini-game begins, the server performs a step S21 for moving at least one block-shaped puzzle having a random image corresponding to the character type in a random direction.

There is at least one character used when the game is performed, there a puzzle having a random image for each character, and the same character has a puzzle with the same image.

The server performs a step S22 for moving puzzles in a random direction and allowing the moved puzzles to form a specific pattern with the same puzzles that were moved.

Here, for example, the specific pattern represents a form in which at least three same puzzles are provided in a direction, and it includes a case in which three same puzzles are sequentially provided in a horizontal direction, a case in which four same puzzles are sequentially provided in a vertical direction, and a case in which three same puzzles are sequentially provided in a diagonal direction.

When the same puzzles form a specific pattern, the server performs a step S23 for correcting the capability point of the character corresponding to the puzzle that is removed simultaneously when the puzzles having formed a specific pattern are removed.

In this instance, the server can correct the capability point of the character corresponding to the removed puzzle and can transmit a capability point correction result to the user terminal.

The server performs a step S24 for determining whether a predetermined time is passed, and when the predetermined time is found to be passed, the server performs a step S25 for finishing the mini-game and storing a character capability point correction result.

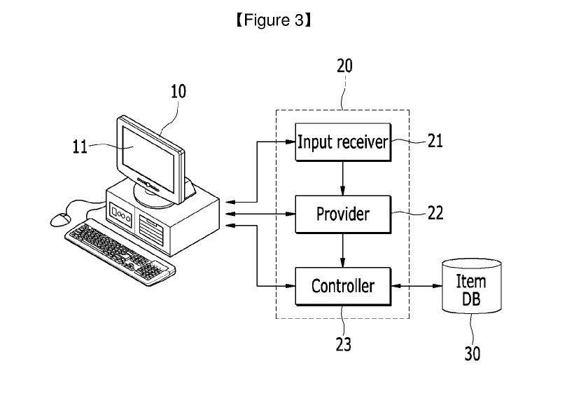

FIG. 3 shows a block diagram of a configuration on a server for providing a simulation game according to an exemplary embodiment of the present invention.

Referring to FIG. 3, a server 20 for providing a simulation game according to an exemplary embodiment of the present invention includes an input receiver 21, a provider 22, and a controller 23.

The user can access the game server 20 through a user terminal 10 and can play a game, and in this instance, the user's information (in detail, the user's owned item information) and the items' information are stored in an item database 30.

The input receiver 21 receives an input for beginning a simulation game that is a game for artificial intelligence of a computer to display a playing result in place of the user from among the game types existing in the multi-play mode that is a game mode in which the users play a game by themselves from the user terminal.

The input receiver 21 transmits a game type selecting menu as a menu for selecting one of game types existing in the multi-play mode to the user terminal when receiving a game generating input from the user terminal, generates a simulation game when selecting a simulation game from the game type selecting menu, and receives an input for beginning a simulation game from the user terminal when an opponent participates in the simulation game.

The provider 22 provides a mini-game that is a game for correcting the capability point of the simulation game character. The second provider 22 provides a mini-game for correcting the capability point of the character corresponding to a removed puzzle simultaneously when the puzzle having formed a specific pattern is removed, and when at least one block-shaped puzzle having a random image corresponding to a type of the game character moves in a specific direction and the puzzle forms a specific pattern with the same puzzles that were moved.

The controller 23 performs at least one predetermined stage that must be preceded before a simulation game playing begins, and controls provision of the mini-game when receiving a simulation game begin input. The controller 23 corrects the capability point of the character according to a result of the mini-game, and controls to start the simulation game based on the corrected capability point of the character.

In this instance, the controller 23 controls to perform at least one predetermined stage that must be preceded, as a stage for setting at least one game factor, and a stage for exchanging at least one character playing in the game or changing a state of the at least one character.

The controller 23 finishes the mini-game when a predetermined time expires, stores the capability point of the character corrected until the mini-game finishes, and applies the same to the simulation game.

Further, the controller 23 transmits the capability point correction result of the character to the user terminal 10 so that the user may check it.

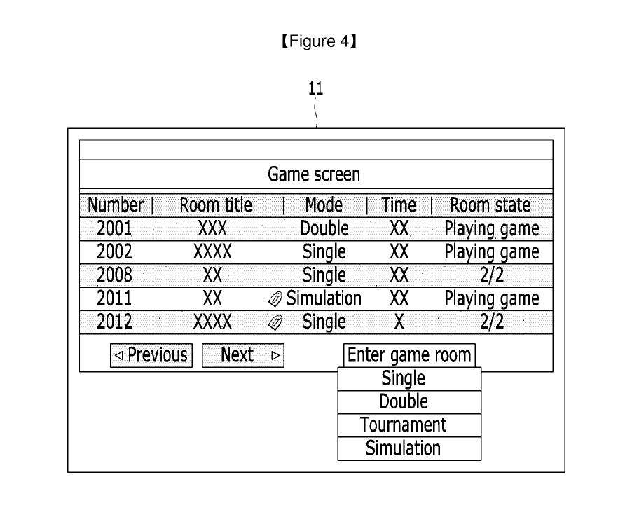

FIG. 4 to FIG. 7 show exemplary game screens that are applicable according to respective exemplary embodiments of the present invention.

Referring to FIG. 4, for example, a simulation game displayed with a game room generating menu on a game screen is shown. When the user uses a pointing means such as a mouse to select a game room entering menu, a simulation menu for performing a simulation game linked with the game room entering menu is displayed.

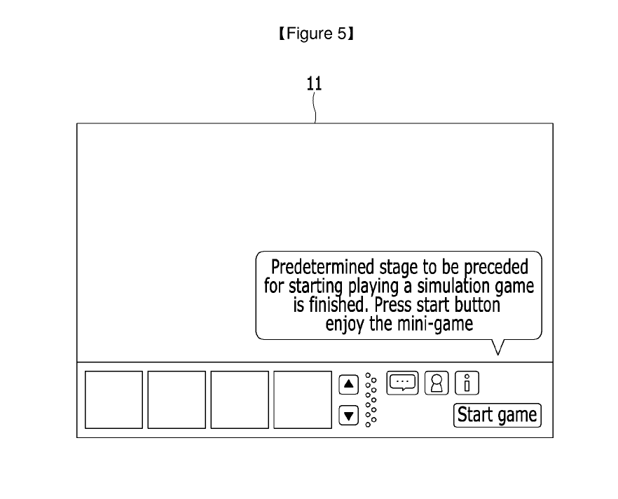

Referring to FIG. 5, there is an example that, when the predetermined stage that must be preceded is performed, a message for notifying inputting of a start button so as to start a mini-game since the predetermined stage that must be preceded before a simulation game playing begins is finished is generated and displayed on a display screen 11 of the user terminal.

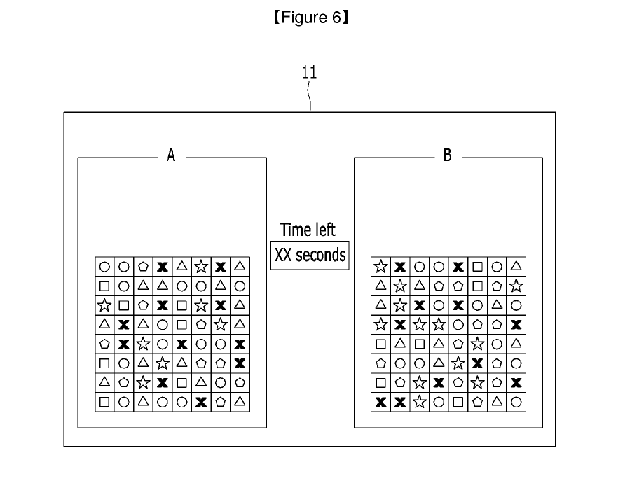

Referring to FIG. 6, a mini-game screen displayed on the user terminal screen 11 is shown. A remaining time is displayed on the mini-game screen, the game is finished when a predetermined time is passed, and the corrected capability point of the character is maintained until the game finishes so that it may be used for the simulation game.

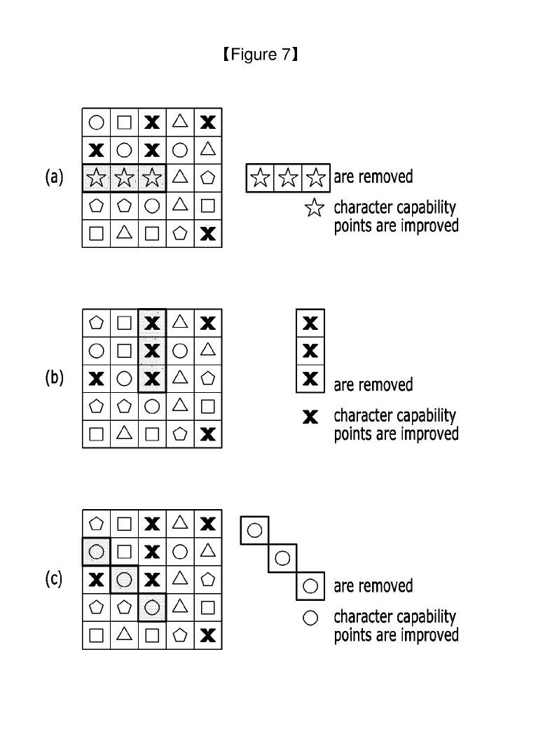

Referring to FIG. 7, an exemplary embodiment of the mini-game is shown. FIG. 7 (a) shows an example in which three same puzzles having a star-shaped character are sequentially provided in the horizontal direction to form a specific pattern, showing that the capability point of the star-shaped character is improved when the star-shaped specific pattern is removed.

FIG. 7 (b) shows an example in which three same puzzles having an x-shaped character are sequentially provided in the perpendicular direction to form a specific pattern, showing that the capability point of the star-shaped character is improved when the x-shaped specific pattern is removed.

FIG. 7 (c) shows an example in which three same puzzles having a circular character are sequentially provided in the diagonal direction to form a specific pattern, showing that the capability point of the circular character is improved when the circular specific pattern is removed.

The method for providing a simulation game according to the exemplary embodiment of the present invention described above may be executed by the applications (including programs included in a platform, an operating system, or the like which is basically installed in the terminal) which are basically installed in the terminal, and may also be executed by the applications (i.e., programs) which are directly installed in the terminal by the user via the application store server or the application providing server such as the web server associated with the applications or the corresponding services. In this respect, the method for providing a simulation game according to the exemplary embodiment of the present invention described above may be implemented by the applications (i.e., programs) which are basically installed or directly installed by the user in the terminal, and may be recorded in a computer readable recording medium of the terminal and the like.

The programs are recorded in the computer readable recording medium and are executed by the computer, such that the above-mentioned functions may be executed.

As described, in order to execute the method for providing a simulation game according to the exemplary embodiment of the present invention, the above-mentioned programs may include codes which are coded with computer languages such as C, C++, JAVA, machine language, and the like which may be read by a processor (CPU) of the computer.

The code may include a function code associated with a function of defining the above-mentioned functions, and may also include an execution procedure related control code required to allow the processor of the computer to execute the above-mentioned functions as a predetermined procedure.

The code may further include a memory reference related code indicating at which location (address number) of the memory inside or outside the computer additional information or media required to allow the processor of the computer to execute the above-mentioned functions are referenced.

Further, to allow the processor of the computer to execute the above-mentioned functions, when the processor needs to communicate with any other computers or servers, etc. at a remote location, the code may further include a communication-related code about how the processor of the computer communicates with any other computers or servers at a remote location or what information or media the processor of the computer transmits and receives at the time of the communication, by using the communication module (for example, wired and/or wireless communication module) of the computer.

A functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network, and thus stores and executes a computer readable code in a distributed manner. In this case, at least any one computer among a plurality of distributed computers may execute a part of the above-mentioned functions and transmit the executed results to at least one of other distributed computers, and the computer receiving the result may also execute a part of the above-mentioned functions and provide the executed results to other distributed computers.

Particularly, a computer readable recording medium recorded with applications which are programs for executing the method for providing a simulation game according to the exemplary embodiment of the present invention may be a storage medium (for example, a hard disk and the like) included in an application store server or an application providing server such as a web server associated with applications or corresponding services, and the like, or an application providing server itself.

A computer which may read a recording medium recorded with applications which are programs for executing the method for providing a simulation game according to the exemplary embodiment of the present invention may include not only general PCs such as a typical desktop and a laptop, but also mobile terminals such as a smart phone, a tablet PC, personal digital assistants (PDAs), and mobile communication terminals, and is to be construed as all computable devices.

Further, when a computer which may read a recording medium recorded with applications which are programs for executing the method for providing a simulation game according to the exemplary embodiment of the present invention is mobile terminals such as a smart phone, a tablet PC, a personal digital assistant (PDA), and a mobile communication terminal, the applications are downloaded from an application providing server to a general PC and thus may also be installed in the mobile terminal by a synchronization program.

As described above, even though it is described that all constituent elements of the exemplary embodiment of the present invention are combined as one or combined to be operated, the present invention is not limited to the exemplary embodiment. That is, within the scope of purpose of the present invention, one or more constituent elements may be selectively combined to be operated. Further, all the constituent elements may be implemented as one independent piece of hardware, but a part or all of the constituent elements are selectively combined to be implemented as a computer program including a program module which performs a part or all functions and which is combined in one or a plurality of pieces of hardware. Codes and code segments which configure the computer program may be easily deduced by those skilled in the art. Such a computer program is stored in a computer readable medium to be read and executed by the computer to implement the exemplary embodiment of the present invention. A storage medium of the computer program may include a magnetic recording medium and an optical recording medium.

Further, unless explicitly described to the contrary, the word “comprise”, “configure”, and “have” will be understood to imply the inclusion of stated elements but not the exclusion of any other elements. Unless differently defined, all terminologies including technical or scientific terminology may have the same meaning which is generally understood by those skilled in the art. Terminologies defined in generally used dictionary shall be construed such that they have meanings matching those in the context of a related art, and shall not be construed as having ideal or excessively formal meanings unless they are clearly defined in the present application.

Although the exemplary embodiments have been described, those skilled in the art will readily appreciate that many modifications are possible without materially departing from the novel teachings and advantages. Therefore, the exemplary embodiments disclosed in the present invention are not limited to the technical idea of the present invention and are to explain these exemplary embodiments, and the scope of the technical idea of the present invention is not limited by these exemplary embodiments. The protection range of the present invention should be construed by the claims below, and all technical ideas within an equivalent range of thought should be construed as being included within the scope of the present invention.

1. A method for providing a simulation game, comprising:
by an online game executing server,
receiving an input for beginning a simulation game that is a game for artificial intelligence of a computer to display a playing result in place of a user from among game types existing in a multi-play mode that is a game mode in which users play a game by themselves from a user terminal;
providing a mini-game that is a predetermined game for correcting a capability point of a character in the game when receiving the input of the simulation game;
correcting the capability point of the character according to a result of the mini-game; and
playing the simulation game based on the corrected capability point of the character.

2. The method of claim 1, wherein
the receiving of an input for beginning a simulation game includes:
receiving a game generating input from the user terminal;
transmitting a game type selecting menu as a menu for selecting one of game types existing in the multi-play mode to the user terminal when receiving the game generating input;
generating the simulation game when selecting the simulation game from the game type selecting menu; and
receiving an input for beginning the simulation game from the user terminal when an opponent participates in the simulation game.

3. The method of claim 1, wherein
the mini-game includes:
moving at least one block-shaped puzzle having a random image corresponding to a type of the game character in a specific direction;
allowing the moved puzzle to form a specific pattern with same puzzles that were moved; and
correcting a capability point of a character corresponding to a removed puzzle simultaneously when the puzzle having formed a specific pattern is removed.

4. The method of claim 3, further including
finishing the mini-game when a predetermined time is passed.

5. The method of claim 3, further including
transmitting a capability point correction result of the character to the user terminal stage.

6. The method of claim 1, further including,
when receiving an input for beginning the simulation game,
performing at least one predetermined stage that must be preceded before the simulation game playing starts.

7. The method of claim 6, wherein
the at least one predetermined stage that must be preceded includes
exchanging at least one character played in the game or changing a state of the at least one character, as setting of the at least one game factor.

8. A server for providing a simulation game comprising:
an input receiver for receiving an input for beginning a simulation game that is a game for a computer artificial intelligence to display a playing result in place of a user from among game types existing in a multi-play mode that is a game mode in which users can play a game by themselves from a user terminal;
a provider for providing a mini-game that is a predetermined game performed to correct a capability point of a character in the game when receiving the input of the simulation game; and
a controller for correcting the capability point of the character according to a result of the mini-game, and controlling to play the simulation game based on the capability point of the corrected character.

9. The server of claim 8, wherein
the input receiver transmits a game type selecting menu as a menu for selecting one of game types existing in the multi-play mode to the user terminal when receiving a game generating input from the user terminal, generates the simulation game when selecting the simulation game from the game type selecting menu, and receives an input for beginning the simulation game from the user terminal when an opponent participates in the simulation game.

10. The server of claim 8, wherein
the provider provides a mini-game for moving at least one block-shaped puzzle having a random image corresponding to a type of the game character in a specific direction, allowing the moved puzzle to form a specific pattern with same puzzles that were moved, and correcting a capability point of a character corresponding to a removed puzzle simultaneously when the puzzle having formed a specific pattern is removed.

11. The server of claim 10, wherein
the controller finishes the mini-game when a predetermined time is passed.

12. The server of claim 10, wherein
the controller transmits a capability point correction result of the character to the user terminal.

13. The server of claim 8, wherein
the controller controls to perform at least one predetermined stage that must be preceded before the simulation game playing begins when receiving the input for beginning the simulation game.

14. The server of claim 13, wherein
the at least one predetermined stage that must be preceded includes,
as a stage for setting the at least one game factor, exchanging at least one character playing in the game or changing a state of the at least one character.

15. A computer readable medium for recording a program for realizing a method for providing a simulation game comprising:
by an online game executing server,
receiving an input for beginning a simulation game that is a game for artificial intelligence of a computer to display a playing result in place of a user from among game types existing in a multi-play mode that is a game mode in which users can play a game by themselves from a user terminal;
providing a mini-game that is a predetermined game performed to correct a capability point of a character in the game when receiving the input of the simulation game;
correcting the capability point of the character according to a result of the mini-game; and
playing the simulation game based on the capability point of the corrected character.
